(19) United States
(12) Patent Application Publication
(10) Pub. No.: US 2019/0028137 A1
(43) Pub. Date: Jan. 24, 2019

(54) RADIO-FREQUENCY (RF) CONNECTORS WITH INTEGRATED RADIO-FREQUENCY DEVICE

(71) Applicant: SKYWORKS SOLUTIONS, INC., Woburn, MA (US)

(72) Inventor: John David O'NEILL, Coto de caza, CA (US)

(21) Appl. No.: 16/035,697

(22) Filed: Jul. 15, 2018

Related U.S. Application Data
(60) Provisional application No. 62/533,750, filed on Jul. 18, 2017.

(51) Int. Cl. H04B 1/44

(52) U.S. Cl. CPC H04B 1/44; H04M 1/725

(57) ABSTRACT

Radio-frequency connectors with integrated radio-frequency devices. In some embodiments, a radio-frequency connector includes an antenna port configured to transmit or receive a first radio-frequency signal, a transceiver port configured to transmit or receive a second radio-frequency signal and a radio-frequency integrated circuit device configured to process the first radio-frequency signal or the second radio-frequency signal.

### CROSS-REFERENCE TO RELATED APPLICATION(S)

This application claims priority to U.S. Provisional Application No. 62/533,750 filed Jul. 18, 2017, entitled RADIO-FREQUENCY (RF) CONNECTORS WITH INTEGRATED RADIO-FREQUENCY DEVICE, the disclosure of which is hereby expressly incorporated by reference herein in its respective entirety.

### BACKGROUND

### Field

The present disclosure relates to radio-frequency connectors for radio-frequency signals transmitted and received by an antenna.

### Description of the Related Art

In wireless applications, a signal to be transmitted is typically generated by a transceiver, amplified by a power amplifier, filtered by a filter, and routed to an antenna by a switch network. Such a signal transmitted through the antenna has a relatively high power.

In a generally reverse manner, a relatively weak signal received through an antenna is typically routed from the antenna by a switch network, filtered by a filter, amplified by a low-noise amplifier, and provided to the transceiver. The power amplification, filtering and switching may occur on a radio-frequency integrated circuit (RFIC) chip. In some applications, the amplification can be achieved in close proximity to the antenna to reduce loss of the relatively weak signal.

### SUMMARY

In some implementations, the present disclosure relates to a radio-frequency connector comprising an antenna port configured to transmit or receive a first radio-frequency signal, a transceiver port configured to transmit or receive a second radio-frequency signal and a radio-frequency integrated circuit device configured to process the first radio-frequency signal or the second radio-frequency signal.

In some embodiments, the radio-frequency integrated circuit device is at least partially embedded in the radio-frequency connector. In some embodiments, the radio-frequency integrated circuit device is implemented on a surface of the radio-frequency connector.

In some embodiments, the radio-frequency integrated circuit device is coupled to the antenna port and coupled to the transceiver port. In some embodiments, the radio-frequency integrated circuit device is configured to receive the first radio-frequency signal from the antenna port and transmit a processed first radio-frequency signal to the transceiver port as the second radio-frequency signal. In some embodiments, the radio-frequency integrated circuit device is configured to receive the second radio-frequency signal from the transceiver port and transmit a processed second radio-frequency signal to the antenna port as the first radio-frequency signal.

In some embodiments, the radio-frequency integrated circuit device is implemented as a semiconductor die. In some embodiments, the radio-frequency integrated circuit device is implemented as a chip-scale-packaged part. In some embodiments, the radio-frequency integrated circuit device is implemented as a radio-frequency module.

In some embodiments, the radio-frequency module includes one or more power amplifiers, one or more filters and one or more switches.

In some embodiments, further comprises a set of I/O connectors coupled to the radio-frequency integrated circuit. In some embodiments, further comprises a set of one or more grounding legs coupled to the radio-frequency integrated circuit and a set of one or more signal legs coupled to the radio-frequency integrated circuit. In some embodiments, the radio-frequency connector, the set of grounding legs and the set of signal legs are composed substantially of the same material. In some embodiments, the set of grounding legs and the set of signal legs are directly connected to a body of the radio-frequency connector.

In some embodiments, the transceiver port of the radio-frequency integrated circuit device is coupled to a transceiver of a wireless device. In some embodiments, the antenna port of the radio-frequency integrated circuit device is coupled to an antenna element of a wireless device.

In some teachings, the present disclosure relates to a method for operating a radio-frequency connector of a wireless device comprising providing a radio-frequency connector with a radio-frequency integrated circuit device configured to process a first radio-frequency signal associated with an antenna port of the radio-frequency connector or a second radio-frequency signal associated with a transceiver port of the radio-frequency connector. The method may further comprise receiving the second radio-frequency signal at the radio-frequency integrated circuit from the transceiver port, processing the second radio-frequency signal at the radio-frequency integrated circuit and transmitting a processed second radio-frequency signal as the first radio-frequency signal to the antenna port. In some embodiments, processing the second radio-frequency signal includes amplifying the second radio-frequency signal.

In a number of implementations, the present disclosure relates to a wireless device that includes an antenna configured to facilitate transmission and reception of radio-frequency signals and a front-end system implemented between a transceiver and the antenna, the front-end system including a radio-frequency connector having an antenna port configured to transmit or receive a first radio-frequency signal, a transceiver port configured to transmit or receive a second radio-frequency signal and a radio-frequency integrated circuit device configured to process the first radio-frequency signal or the second radio-frequency signal.

In some embodiments, the wireless device can be, for example, a cellular phone.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 depicts a conventional RF module coupled to an antenna, in accordance with some implementations.

FIG. 2A illustrates a side profile of an example RF connector, in accordance with some implementations.

FIG. 2B illustrates a bottom-view of an example RF connector, in accordance with some implementations.

FIG. 2C illustrates an interior, bottom-view of an example RFIC embedded in an example RF connector, in accordance with some implementations.

FIG. 3A illustrates a side profile of another example RF connector, in accordance with some implementations.

FIG. 3B illustrates a side profile of another example RF connector having one or more I/O ports, in accordance with some implementations.

FIG. 3C illustrates a bottom-view of another example RF connector having one or more I/O ports, in accordance with some implementations.

FIG. 3D illustrates an interior, bottom-view of an example RFIC embedded in another example RF connector having one or more I/O ports, in accordance with some implementations.

FIG. 4A illustrates a side profile of an example RF connector, in accordance with some implementations.

FIG. 4B illustrates a bottom-view of an example RF connector, in accordance with some implementations.

FIG. 5A illustrates a block diagram of an example RF module, in accordance with some implementations.

FIG. 5B illustrates a more detailed block diagram of an example RF module, in accordance with some implementations.

FIG. 6 depicts a wireless device having one or more features as described herein.

### DETAILED DESCRIPTION OF SOME EMBODIMENTS

The headings provided herein, if any, are for convenience only and do not necessarily affect the scope or meaning of the claimed invention.

### Introduction

Disclosed herein are, among others, examples related to radio-frequency (RF) connectors (e.g., SubMiniature version B (SMB) connectors, SubMiniature version A (SMA) connectors, etc.) with integrated RF devices/modules (e.g., that includes an integrated semiconductor die, an integrated circuit, input/output (I/O) ports/pins, etc.).

### RF Modules:

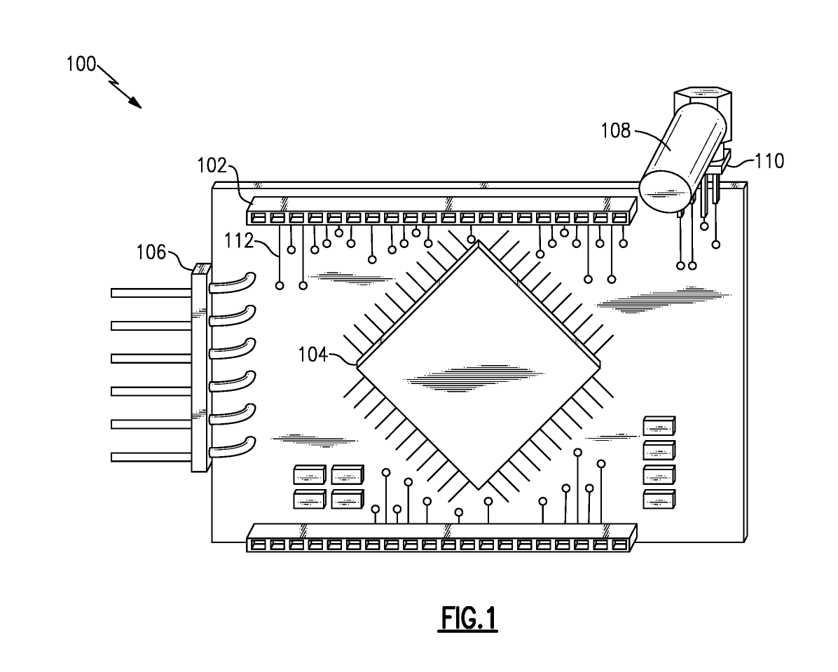

FIG. 1 illustrates an example RF module 100 with a radio-frequency integrated circuit (RFIC) chip 104 placed on it. FIG. 1 illustrates that an RFIC maybe be mounted on a substrate of a printed circuit board (PCB), as shown, along with one or more input/output (I/O) ports 102 and/or one or more I/O pins 106. The one or more I/O ports, pins or other forms of connectors may facilitate transfer of signals from external components in an electronic device, such as, but not limited to power management circuitry, baseband transceiver circuitry and/or memory.

The RF module 100 illustrates an antenna 108 coupled to the PCB, through RF connector 110. RF connector 110 may have one or more legs or pins configured to be soldered or otherwise connected to the PCB of RF module 100. In some embodiments, RF connector 110 can be configured to insert into a socket or snapped onto RF module 100. RF connector 110 may be a standard connector, such as an SMA or SMB connector. In some embodiments, signals, power and/or ground are provided to and from the various connectors (e.g, I/O ports 102), the RFIC 104 and antenna 108 by traces 112 on the RF module 100.

Radio-frequency (RF) semiconductor device packages may be used to encapsulate, protect, and connect a semiconductor/integrated circuit die 104 (or other components) to other devices. One example of a semiconductor package is a quad flat no-leads (QFN) package where the semiconductor die 104 is fixed to a die pad and wire-bonds are made between the pads of the integrated circuit die and the package leads. The package leads may facilitate the connection of the device inputs and outputs to other circuit elements of the RF module 100 including antenna 108 in the context of an RF integrated circuit device (such as a power amplifier).

For a QFN package, plastic is overmolded to encapsulate the semiconductor die 104 and the die itself is typically attached to a metal flag that is grounded and thermally connected to dissipate heat generated within the IC die. In effect, the package may act to protect the die, connect the I/O of the circuit (with other devices/components), and provide a thermal pathway for the dissipation of heat that is generated by the integrated circuit (IC) or die in operation. The package itself may also minimize parasitic inductance and capacitance so as not to burden the IC input and output ports with unwanted RF load. However, regardless of the design of the package, the package containing the die may be placed upon a printed circuit board (or other type of board) with traces 112 that lead to the RF antenna connector 110. The traces 112 leading to the RF antenna connector 110 may load the RF output or input port of the RFIC chip 104 such that signals are lost or distorted (e.g., phase shift, dispersion, RF signal attenuation, etc.). Thus, it may be useful to provide a compact and protective package that provides thermal dissipation performance and helps to minimize RF loss between the packaged RF IC die 104 and the connector 110 to which an antenna element 108 (or other elements) may be attached, as illustrated in FIG. 1. Moreover, it may also be useful to reduce the size of the packaged RF semiconductor device 104 and conserve the total volume and/or area of the RF module 100 comprising the printed circuit board, semiconductor package, and connectors (e.g., I/O ports and pins 102 and 106).

RF Connectors with Integrated ICs:

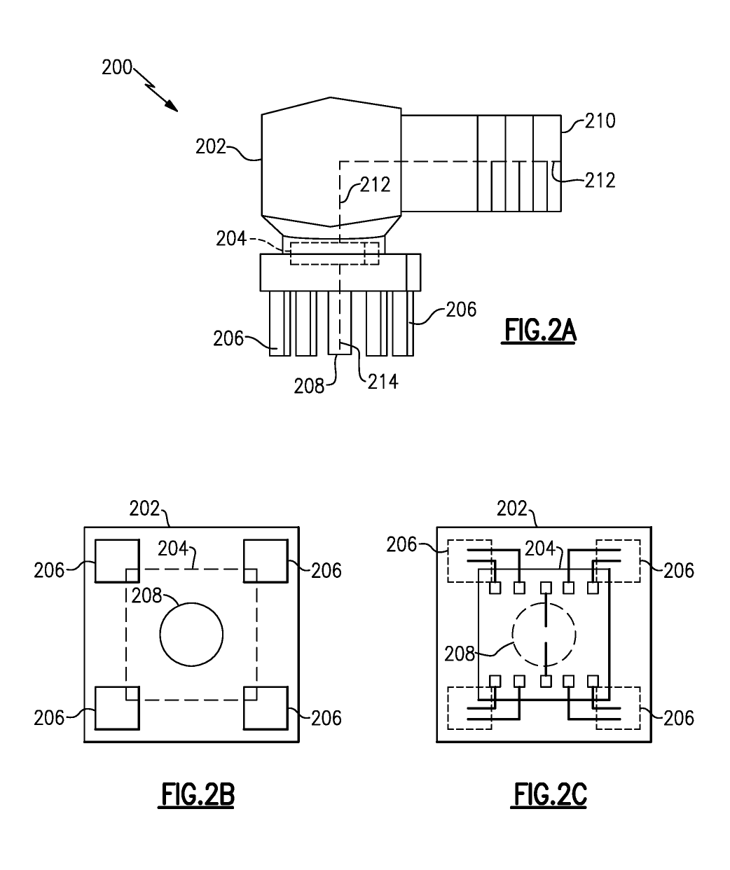

FIG. 2A illustrates a side-view of an RF connector 200 with an embedded RFIC device 204, in accordance with some implementations. In some embodiments, RF connector 200 is configured as a standard connector, such as a SubMiniature version B (SMB) connector or SubMiniature version A (SMA) connector. As illustrated in the side-view of RF connector 200, a semiconductor device 204, such as a die, packaged part (e.g., QFN part), or module comprising an RFIC can be placed at least partially inside it, and connected to an RF output signal 212 and an RF input signal 214. In some embodiments, integrating an RFIC device 204 (e.g., semiconductor/IC die) within an RF connector 200 may allow a system to miniaturize/reduce the size of an RF system/solution. In other embodiments, integrating an RFIC device 204 within the RF connector 200 may provide improved thermal dissipation using the thermal mass of metal that is used in the RF connector 200. In further embodiments, integrating an RFIC device 204 within the RF connector 200 may also reduce signal loss and distortion due to proximity of the RFIC device 204 to the connector 200 by bypassing board traces.

The RF connector 200 may include a nut mechanism 210, which may, for example, be a male or female part comprising a port or pin for RF output signal 212, and configured to connect to an antenna element. RF connector may also include a body portion 202, one or more grounding legs 206 and one or more signal legs 208. Grounding legs 206 may be configured to be connected to ground terminals, ports or other connections (e.g., on a PCB or RF module). A signal leg 208 may be configured to permit transmission and/or reception of an RF signal, such as on an RF module, as shown in FIG. 1.

As shown in FIG. 2A, in some embodiments, an RF connector 200 with an embedded or implemented RFIC device 204, may be configured to perform some or all of the functionality of the RF module 100 described above with respect to FIG. 1. For example, RFIC device 204 may include certain RF front-end (RFFE) architecture, such as power amplification circuitry, filters, switches and/or low-noise-amplifiers. As such, the close proximity of RFIC device 204 to RF output signal 212, may provide for better signal processing and overall performance of a system or module coupled to RF connector 200. While signal path 212 is referred to as an RF output signal, and signal path 214 is referred to as an RF input signal, one of ordinary skill in the art will understand that in some embodiments, an RF signal is received by RFIC device 204 from signal path 212, and transmitted to another device or component of a device (e.g., a baseband transceiver) over signal path 214.

In some embodiments, some or all of the material of RF connector 200 is made of a material that can be soldered to (e.g., to have connectors of RFIC device 204 soldered to RF connector 200), and/or be soldered onto another material. For example, RFIC device 204 may be a chip-scale-package (CSP) configured to be directly soldered to at least a portion of RF connector 200. Additionally, or alternatively, RF connector 200 may be configured to be soldered to a PCB, RF module or some other board, substrate or device.

In some embodiments, a signal leg 208 is insulated from the one or more grounding legs 206, and/or body 202, and/or nut mechanism 210 of RF connector 200. In some embodiments, body 202 and/or grounding legs 206 and/or signal leg 208 of RF connector 200 are composed substantially of brass. In some embodiments, one or more signal legs 208 are insulated from other portions of RF connector 200 by an insulating material such as Teflon. In some embodiments, the material of RF connector 200 and/or body 202 is effective at dissipating heat away from RFIC device 204.

FIG. 2A illustrates RF output signal 212, RFIC device 204 and RF input signal 214 with dotted lines indicating that they are internal to RF connector 200, from the side view. In some embodiments, at least a portion of RFIC 204 may be implemented outside, but in direct contact with RF connector 200. For example, RFIC 204 may be implemented on a side of body 202 of RF connector 200, or partially embedded in RF connector 200, such as in a recessed pocket on a side of body 202. FIG. 2A illustrates that in some embodiments, body 202 and legs 206 and 208 may all be seamlessly connected or formed together. In some embodiments, at least a portion of RF connector 200 may be formed before embedding or implementing RFIC device 204 therein.

FIG. 2B illustrates a bottom-view of RF connector 200, in accordance with some implementations. In the example shown in FIG. 2B, RFIC device 204 is embedded in RF connector 200, so it is not visible from a bottom-view perspective as shown in FIG. 2B. As discussed above, in this example, RF connector 200 is shown with four grounding legs 206, distributed in four corners of the base of body 202, along with a signal leg 208 in the center. In some embodiments RF connector 200 may comprise a plurality of signal legs 208. For example, additional signal legs 208 may be implemented to provide power and/or control signals to RFIC device 204.

FIG. 2C illustrates an interior, bottom-view of RFIC device 204 embedded in RF connector 202, in accordance with some implementations. As shown in FIG. 2C, in some embodiments, connections may be made between RFIC device 204 (e.g., from pads, pins, solder balls, posts of a die or packaged part), to portions of RF connector 202. For example, ground pads on a packaged RFIC device 204 may be soldered or otherwise coupled to grounding legs 206, as shown in FIG. 2C. One or more connectors on RFIC device 204 may be connected to one or more signal legs 208, also as shown.

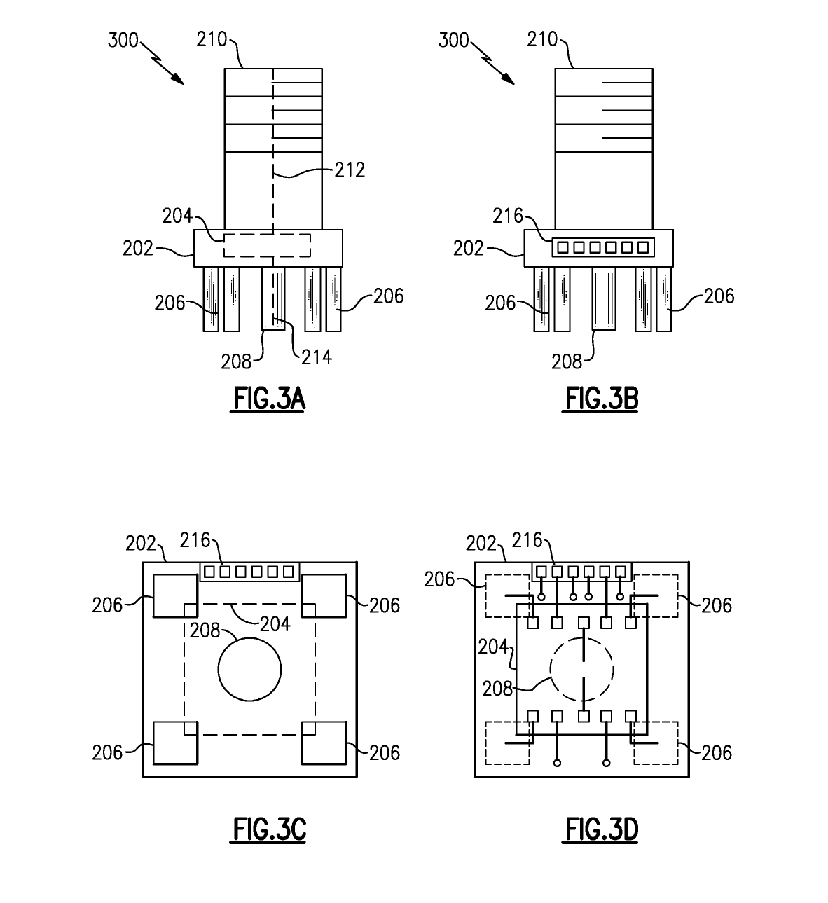

FIG. 3A illustrates a side profile of another example RF connector 300, in accordance with some implementations. RF connector 300 illustrates that different orientations or structures may be utilized to implement an RFIC device 204 on or within an RF connector such as RF connector 300. To the extent that any aspects of RF connector 300 have been discussed above with respect to FIGS. 2A-2C and RF connector 200, they are not repeated.

FIG. 3B illustrates a side profile of RF connector 300 having a set of one or more I/O connectors 216. In some embodiments, RFIC device 204 may require additional signals and/or supply voltages from a source external to RF connector 300. The set of I/O connectors 216 illustrates one mechanism for providing access to such additional signals and/or supply voltages, however one of ordinary skill in the art will understand that the location and format of connectors (e.g., pads, pins, ports, posts, solder balls etc.) are not limited to the ones illustrated.

FIG. 3C illustrates a bottom-view of RF connector 300 having one or more I/O ports, in accordance with some implementations. As shown in FIG. 3C, some or all of a set of I/O connectors 216 may be placed on the same side of body 202 of RF connector 300, as the one to which grounding legs 206 and/or signal leg(s) 208 are connected to. Such an orientation may facilitate a socket or snap-on connection mechanism on an RF module or PCB, for example.

FIG. 3D illustrates an interior, bottom-view of RFIC device 204 embedded in RF connector 300 having a set of one or more I/O connectors 216, in accordance with some implementations. The example in FIG. 3D illustrates that in some embodiments, signals and/or power supply connections between the set of I/O connectors 216 and RFIC device 204 may be implemented by one or more traces (e.g., on a module or PCB), or other forms of connections.

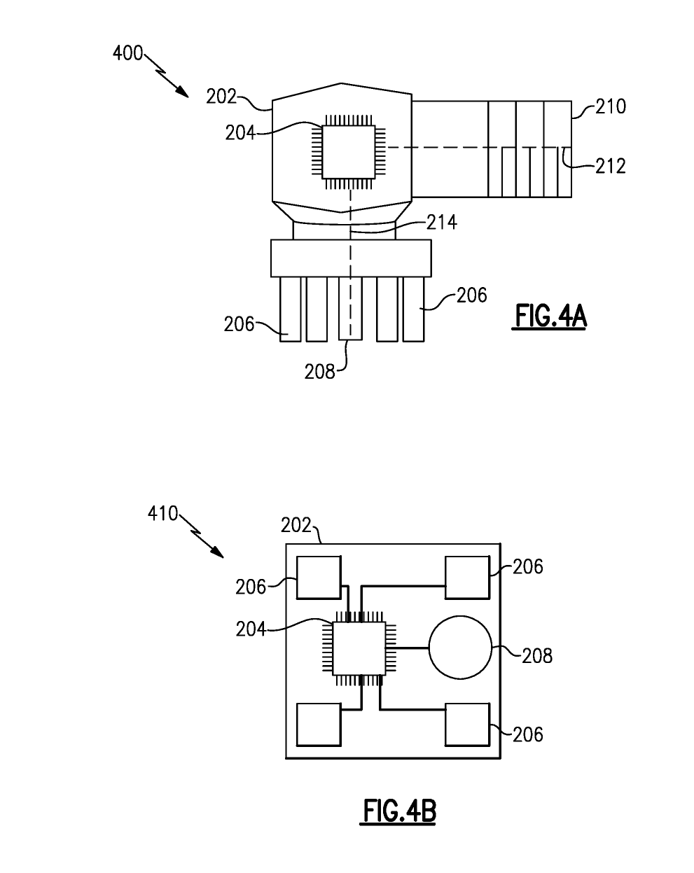

FIG. 4A illustrates a side profile of an example RF connector 400, in accordance with some implementations. The example shown in FIG. 4A illustrates that in some embodiments an RFIC device 204 may be implemented on a surface of RF connector 400, and/or body 202 thereof. In some embodiments, the RFIC device 204 may be partially embedded on a side of RF connector 400 and/or body 202, such as in a recessed cavity. In some embodiments, such a recessed cavity may be configured to allow the top of the RFIC device 204 to be level or flush with the rest of the surrounding portion of the RF connector 400.

FIG. 4B illustrates a bottom-view of an example RF connector 410, in accordance with some implementations. As shown in FIG. 4B, in some embodiments, an RFIC device 204 may be implemented on the bottom of RF connector 410, on the same side of body 202 of RF connector 410, as the one to which grounding legs 206 and/or signal leg(s) 208 are connected to. In this example, traces or connections between RFIC device 204 and grounding legs 206 and/or signal leg(s) 208 may also be implemented on the same side. Alternatively and/or additionally, signal traces or other connections between RFIC device 204 and grounding legs 206, signal leg(s) 208 and/or other I/O connectors may be implemented within RF connector 410. In some embodiments, signal and/or power connections may be made directly to RFIC device 204 if it is implemented at least partially on a surface of an RF connector.

In some embodiments, a method is provided for operating a radio-frequency connector of a wireless device. The method may include providing a radio-frequency connector with a radio-frequency integrated circuit device configured to process a first radio-frequency signal associated with an antenna port of the radio-frequency connector or a second radio-frequency signal associated with a transceiver port of the radio-frequency connector. For example, as shown in FIG. 2A, RFIC device 204 is provided in RF connector 200. The method may include receiving the second radio-frequency signal at the radio-frequency integrated circuit from the transceiver port. For example, as shown in FIG. 2A, the RFIC device 204 may receive an RF signal via signal leg 208. The method may include processing the second radio-frequency signal at the radio-frequency integrated circuit, and transmitting a processed second radio-frequency signal as the first radio-frequency signal to the antenna port. For example, RFIC device 204 may receive the RF signal via signal leg 208, process the signal and transmit it over output signal 212. In some embodiments, processing the second radio-frequency signal includes amplifying the second radio-frequency signal.

### RF Module for Implementation:

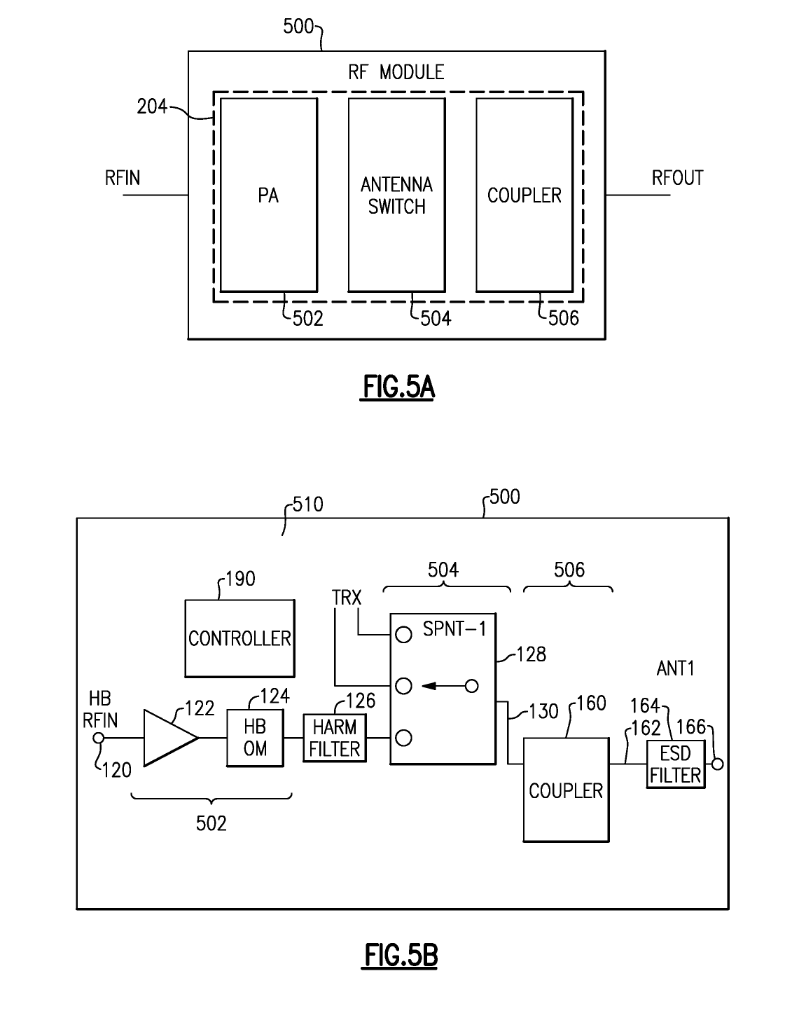

FIG. 5A illustrates a block diagram of an example RF module 500, in accordance with some implementations. In FIG. 5A, the RF module 500 is shown to include a PA 502, an antenna switch 504, and a coupler 506. The RF module 500 is shown to receive an input (RFin) and generate an output (RFout) for transmission through an antenna element (e.g., as shown in FIG. 1). In some embodiments, substantially all of the PA 502, the antenna switch 504, and the coupler 506 can be implemented in an RFIC device 204 as described above, and/or the RF module 500. In some embodiments, RFIC device 204 is the entire RF module 500.

FIG. 5B shows an RF module 500 that can be a more specific example of the RF module 500 of FIG. 5A. In FIG. 5B, the RF module 500 is depicted in the example context of a TX FEM (transmitting front end module). However, it will be understood that one or more features of the present disclosure can also be implemented in other types of RF modules.

In the example of FIG. 5B, the TX FEM 500 is shown to include a packaging substrate 510 configured to receive and support a plurality of components. Such a packaging substrate can include, for example, a laminate substrate, a ceramic substrate, etc. The PA component is generally indicated as 502; the antenna switch component is generally indicated as 504; and the coupler component is generally indicated as 506.

By way of an example, the PA component 502 is shown to include a high band (HB) amplification path, however additional paths such as a low band (LB) amplification path and/or mid-band (MB) amplification path may also be shown. RF signals associated with the HB path can be received through an input node 120 as HB_RFin, and be amplified by one or more stages of an HB power amplifier (PA) 122. The amplified output of the HB PA 122 can be passed through, for example, a matching network 124 and a harmonic filter 126, and be provided to the antenna switch 504.

In some embodiments, the antenna switch 504 can include a high band portion 128. For example, if the antenna switch 104 has a DPNT (double-pole N-throw) configuration with the two poles for accommodating two antennas, the high band portion 128 can have an SPXT (single-pole X-throw) configuration. In the example shown in FIG. 5B, the value of X is 3, but it will be understood by one of ordinary skill in the art that other values of X.

In the example of FIG. 5B, the single throw of the high band portion 128 of the antenna switch 504 is shown to be coupled to a first antenna port 166 through path 130, a coupler 160, path 162, and an ESD/filter circuit 164. One of the throws in the high band portion 128 of the antenna switch 504 is shown to be connected to the harmonic filter 126 so as to receive the amplified HB signal. The other throws are shown to be utilized for RX functionality of the high band associated with HB_RFin, and/or TX/RX functionalities of other high bands.

In some embodiments, the coupler 160 can be implemented as an integrated passive device (IPD). In some embodiments, a single IPD can be configured to include two dedicated coupler circuits for the high band and low band channels. In some embodiments, a first IPD can be configured to include a first coupler circuit for the high band, and a separate second IPD can be configured to include a second coupler circuit for the low band. In some embodiments, the foregoing coupler (160) can be configured to detect the transmitting power of the high band signal. As shown in FIG. 5B, the output of the coupler 160 is shown to be routed to antenna port 166.

In the example of FIG. 5B, the TX FEM 500 is shown to further include a controller component 190 configured to facilitate operation of some or all parts of the module 500. Although not shown, the module 500 can also include circuits, connections, etc. configured to facilitate, for example, supply power, bias signal, etc.

In some embodiments, the PA 122 can be implemented in a suitable configuration for RF applications such as cellular applications. For example, GaAs based devices such as HBT devices, or silicon based devices can be utilized.

In some embodiments, the antenna switch 504 can be implemented in a suitable configuration for RF applications such as cellular applications. For example, silicon-on-insulator (SOI) technology can be implemented to effectuate various switching FETs.

In some embodiments, various components associated with the PA component 502, the antenna switch 504, and the coupler component 506 can be implemented as semiconductor die. Such die can be packaged as wirebond type, flip-chip type, or in any combination of known package types.

In some embodiments, a module such as a TX FEM module 500 as described herein can integrate substantially all components that are needed or desired in a phone design, from transceiver outputs to corresponding antennas. As described herein, such a module can include a power amplifier component, corresponding matching networks, harmonic filters, T/R switch, couplers, and ESD protection network.

In some embodiments, the foregoing module 500 and/or RFIC device 204 can be implemented in a very compact size. In addition to the compact size of the module 500, incorporation of one or more components into the module 500 can further reduce the area required on a phone board for functionality provided by the module 500 in a significant manner. Further, BOM cost associated with such functionality can also be reduced significantly.

### Example of a Wireless Device:

In some implementations, an architecture, device and/or circuit having one or more features described herein can be included in a wireless device. Such an architecture, device and/or circuit can be implemented directly in the wireless device, in one or more modular forms as described herein, or in some combination thereof. In some embodiments, such a wireless device can include, for example, a cellular phone, a smart-phone, a hand-held wireless device with or without phone functionality, a wireless tablet, a wireless router, a wireless modem configured to support machine type communications, a wireless access point, a wireless base station, etc. Although described in the context of wireless devices, it will be understood that one or more features of the present disclosure can also be implemented in other RF systems such as base stations.

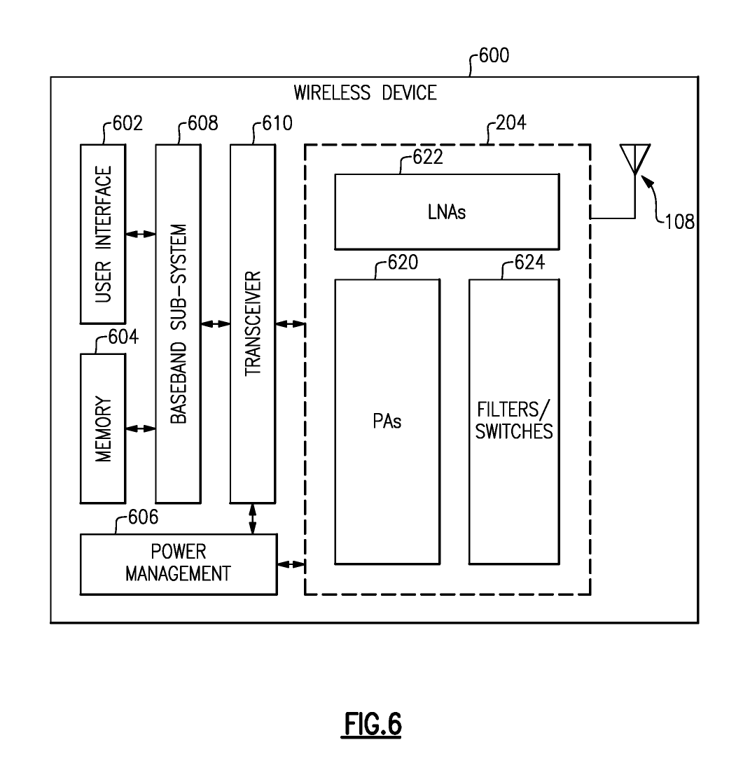

FIG. 6 depicts an example wireless device 600 having one or more advantageous features described herein. In some embodiments, such advantageous features can be implemented in a front-end (FE) architecture device generally indicated as 204. In some embodiments, such a front-end architecture can be implemented as one or more integrated circuits (e.g., an RFIC), die or one or more modules.

As described herein, such an front-end architecture can include, for example, an assembly of PAs 620 for amplifying signals to be transmitted, an assembly of LNAs 622 for amplification of received signals, and an assembly of filters and switches 624 for filtering of signals and routing of signals. As described herein, such a front-end architecture can provide support for one or more antennas, such as antenna 108.

PAs in the PA assembly 620 can receive their respective RF signals from a transceiver 610 that can be configured and operated to generate RF signals to be amplified and transmitted, and to process received signals. The transceiver 610 is shown to interact with a baseband sub-system 608 that is configured to provide conversion between data and/or voice signals suitable for a user and RF signals suitable for the transceiver 610. The transceiver 610 is also shown to be connected to a power management component 606 that is configured to manage power for the operation of the wireless device 600. Such power management can also control operations of the front-end architecture device 204 and other components of the wireless device 600.

The baseband sub-system 608 is shown to be connected to a user interface 602 to facilitate various input and output of voice and/or data provided to and received from the user. The baseband sub-system 608 can also be connected to a memory 604 that is configured to store data and/or instructions to facilitate the operation of the wireless device, and/or to provide storage of information for the user.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

### General Comments:

For the purpose of description, it will be understood that a module can be a physical module and/or a functional block configured to provide a desired modular functionality with one or more devices and/or circuits. For example, a physical module can be a packaged module implemented on a packaging substrate, a packaged die configured to be mounted on a circuit board, or any other physical device configured to provide RF functionality. It will also be understood that a module can include one or more physical devices, including a plurality of physical devices with each sometimes being referred to as a module itself.

Also for the purpose of description, it will be understood that a component can be physical device and/or an assembly of one or more devices and/or circuits configured to provide a functionality. In some situations, a component can also be referred to as a module, and vice versa.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. Claims and their equivalents are intended to cover such forms or modifications as would fall within the scope and spirit of the disclosure.

What is claimed is:

1. A radio-frequency connector, comprising:
an antenna port configured to transmit or receive a first radio-frequency signal;
a transceiver port configured to transmit or receive a second radio-frequency signal; and
a radio-frequency integrated circuit device configured to process the first radio-frequency signal or the second radio-frequency signal.

2. The radio-frequency connector of claim 1 wherein the radio-frequency integrated circuit device is at least partially embedded in the radio-frequency connector.

3. The radio-frequency connector of claim 1 wherein the radio-frequency integrated circuit device is implemented on a surface of the radio-frequency connector.

4. The radio-frequency connector of claim 1 wherein the radio-frequency integrated circuit device is coupled to the antenna port and coupled to the transceiver port.

5. The radio-frequency connector of claim 4 wherein the radio-frequency integrated circuit device is configured to receive the first radio-frequency signal from the antenna port and transmit a processed first radio-frequency signal to the transceiver port as the second radio-frequency signal.

6. The radio-frequency connector of claim 4 wherein the radio-frequency integrated circuit device is configured to receive the second radio-frequency signal from the transceiver port and transmit a processed second radio-frequency signal to the antenna port as the first radio-frequency signal.

7. The radio-frequency connector of claim 1 wherein the radio-frequency integrated circuit device is implemented as a semiconductor die.

8. The radio-frequency connector of claim 1 wherein the radio-frequency integrated circuit device is implemented as a chip-scale-packaged part.

9. The radio-frequency connector of claim 1 wherein the radio-frequency integrated circuit device is implemented as a radio-frequency module.

10. The radio-frequency connector of claim 9 wherein the radio-frequency module includes one or more power amplifiers, one or more filters and one or more switches.

11. The radio-frequency connector of claim 1 further comprising a set of I/O connectors coupled to the radio-frequency integrated circuit.

12. The radio-frequency connector of claim 1 further comprising a set of one or more grounding legs coupled to the radio-frequency integrated circuit and a set of one or more signal legs coupled to the radio-frequency integrated circuit.

13. The radio-frequency connector of claim 12 wherein the radio-frequency connector, the set of grounding legs and the set of signal legs are composed substantially of the same material.

14. The radio-frequency connector of claim 12 wherein the set of grounding legs and the set of signal legs are directly connected to a body of the radio-frequency connector.

15. The radio-frequency connector of claim 1 wherein the transceiver port of the radio-frequency integrated circuit device is coupled to a transceiver of a wireless device.

16. The radio-frequency connector of claim 1 wherein the antenna port of the radio-frequency integrated circuit device is coupled to an antenna element of a wireless device.

17. A method for operating a radio-frequency connector of a wireless device, the method comprising:
providing a radio-frequency connector with a radio-frequency integrated circuit device configured to process a first radio-frequency signal associated with an antenna port of the radio-frequency connector or a second radio-frequency signal associated with a transceiver port of the radio-frequency connector;
receiving the second radio-frequency signal at the radio-frequency integrated circuit from the transceiver port;
processing the second radio-frequency signal at the radio-frequency integrated circuit; and
transmitting a processed second radio-frequency signal as the first radio-frequency signal to the antenna port.

18. The method of claim 17 wherein processing the second radio-frequency signal includes amplifying the second radio-frequency signal.

19. A wireless device comprising:
an antenna configured to facilitate transmission and reception of radio-frequency signals; and
a front-end system implemented between a transceiver and the antenna, the front-end system including a radio-frequency connector having an antenna port configured to transmit or receive a first radio-frequency signal, a transceiver port configured to transmit or receive a second radio-frequency signal and a radio-frequency integrated circuit device configured to process the first radio-frequency signal or the second radio-frequency signal.

20. The wireless device of claim 19 wherein the wireless device is a cellular phone.
